(19) United States
(12) Patent Application Publication
(10) Pub. No.: US 2005/0182643 A1
(43) Pub. Date: Aug. 18, 2005

(54) Method of conducting services on behalf of a governmental organization

(76) Inventor: Kosti Shirvanian, Newport Beach, CA (US)

Correspondence Address: CONNORS ASSOCIATES, 1600 DOVE ST, SUITE 220, NEWPORT BEACH, CA, 92660, US

(21) Appl. No.: 11/021,490

(22) Filed: Dec. 22, 2004

Related U.S. Application Data
(60) Provisional application No. 60/533,088, filed on Dec. 30, 2003.

(51) Int. Cl. G06F 17/60

(52) U.S. Cl. 705/1

(57) ABSTRACT

Services in the nature of a business rather than a governmental function are provided by an operating company jointly owned by a privately owned holding company and a governmental organization. The operating company provides these services in the geographical territory over which the governmental organization has jurisdiction.

### RELATED PATENT APPLICATION & INCORPORATION BY REFERENCE

This application claims the benefit under 35 U.S.C. 119(e) of U.S. provisional patent application Ser. No. 60/533,088, entitled “Method of Conducting Services On Behalf Of A Governmental Organization,” filed Dec. 30, 2003. This related provisional application is incorporated herein by reference and made a part of this utility application. If any conflict arises between the disclosure of the invention in this utility application and that in the above-identified provisional application, the disclosure in this utility application shall govern. Moreover, the inventor incorporates herein by reference any and all U.S. patents, U.S. patent applications, and other documents, hard copy or electronic, cited or referred to in this application.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

The word “company” refers to any agreement or organizational form under which a business is conducted.

The phrase “governmental organization” means any agency, department, city, parish, county, section, division, subdivision, branch, corporation, bureau, office, unit, and the like of any government.

The words “private” and “privately” refer to a non-governmental organization or activity.

### BACKGROUND OF INVENTION

A governmental organization such as for example a municipal corporation may be responsible for providing certain services that are more in the nature of a business rather than a governmental function such as policing, administration of justice, licensing, legislation, regulation, etc. For example, the municipal corporation may conduct business-like service activities such as (a) street sweeping, (b) distributing, maintaining and collecting portable toilets at municipal construction sites, (c) towing of abandoned or illegally parked vehicles, and (d) trash collection. The municipal corporation either conducts operations itself directly through government employees or enters into a “franchise” agreement with an independent contractor who will do the work. For example, a municipal corporation may grant a “franchise” to a company to provide these services in the geographical territory over which the municipal corporation has jurisdiction. The municipal corporation may grant an exclusive or non-exclusive right to provide these services within its geographical territory and require the franchised company to pay an annual-franchise fee and even an on-going royalty. An agreement may be reached between the franchised company and the municipal corporation establishing the terms under which the services will be provided.

The main problem with the governmental organization providing services in the nature of a business directly through government employees is costs and lack of expertise. Although the governmental organization may hire an expert to manage the “service business” on behalf of the governmental organization, this individual still lacks an economic incentive that is provided by an ownership interest. In short, governmental organizations generally do not do a good job managing such a “service business” because they lack the driving force “to make a profit” that is embedded in private ownership of a business.

A privately owned business will go bankrupt if it does not consistently operate profitably. A government-operated “service business” is subsidized by taxpayers if it does not consistently operate profitably. Consequently, many governmental organizations prefer to award “franchises” to independent contractors who conduct and manage the “service business” involved. Sometimes customers pay the independent contractor directly; sometimes the customers pay the governmental organization directly. The governmental organizations derive income in the form of a franchise fee from the independent contractors. Sometimes the franchised company pays an on-going royalty to the governmental organization based on a percent of gross revenues or net profits of the franchised company. This requires the franchised company to submit royalty reports. Because the economic interests of the governmental organization and the franchised trash collection company are antagonistic and not aligned, the franchised company may be lax in accurately reporting financial results of its operations on which royalties are based. Consequently, these reports are not always accurate and the governmental organization must periodically conduct audits, typically by hiring independent accountants to conduct the audit at considerable expense.

The trash collection “service business” is especially problematic. Vegetation may have to be converted into compost. Construction waste and large or difficult to dispose items such a refrigerators may need special handling. Certain materials such as, for example, glass, aluminum, and newspapers, may have to be separated from trash that is sent to a dump or land fill. These separated materials are sent to a recycling center. Some responsibilities of the governmental organization may not be avoided by hiring independent contractors to collect trash. Liability for improper disposal of hazardous materials is imposed on governmental organizations responsible for trash collection. Also, State and/or Federal governments have mandated that a governmental organization responsible for trash collection comply with statutory environmental standards. Otherwise the governmental organization responsible for trash collection will be fined. One standard imposes goals for recycling certain materials and requires reporting of recycled materials. Records and reports indicating compliance with such standards are often demanded and must be submitted on time. In general independent contractors usually do not do the recording and reporting task for the governmental organization. Moreover, governmental organizations are oftentimes deficient in keeping records and reporting.

### SUMMARY OF INVENTION

This invention has one or more features as discussed subsequently herein. After reading the following section entitled “DETAILED DESCRIPTION OF SOME EMBODIMENTS OF THIS INVENTION,” one will understand how the features of this invention provide its benefits. The benefits of this invention include, but are not limited to: (a) greater economic incentives for a private business and a governmental organization to co-operate, (b) more cost effective and efficient operations with greater customer satisfaction, (c) the ability to meet mandated environmental standards, with a guarantee, (d) access to financial resources under advantageous terms, (e) reduction or elimination of delinquent accounts payable, (f) possible tax and other cost savings as a consequence of governmental ownership.

Without limiting the scope of this invention as expressed by the claims that follow, some, but not necessarily all, of its features are:

One, services in the nature of a business rather than a governmental function are provided by an operating company jointly owned by a privately owned holding company and a governmental organization. The jointly owned operating company provides these services in the geographical territory over which the governmental organization has jurisdiction. The services in the nature of a business may include one or more of the following: (1) street sweeping; (2) distributing, maintaining and collecting portable toilets; (3) towing of abandoned or illegally parked vehicles; (4) trash collection. Common to these businesses is that an automotive vehicle is employed in connection with rendering the services that travels throughout the geographical territory over which the governmental organization has jurisdiction.

Two, a legally enforceable agreement, either written or oral, is established between the governmental organization and the holding company, or the operating company, or both of these companies. Provisions of the agreement may include (a) establishing accounting protocols and financial controls for the operating company to determine the profit of the operating company, and (b) sharing profits between the governmental organization and the holding company. There may also be other provisions in the agreement. For example, the operating company may be jointly managed such as through a management committee for the operating company comprising members appointed by both the holding company and the governmental organization. The holding company and the governmental organization may each appoint to the management committee an equal number of committee members, and these members may have the power to employ and discharge a general manger of the operating company responsible for operations.

Three, the agreement can also provide that the governmental organization may (1) have the right to sell all or a portion of the governmental organization's ownership interest in the operating company to anyone, (2) be limited to selling its interest to the holding company, (3) forego selling its ownership interest in the operating company for a predetermined period, (4) agree to sell the governmental organization's ownership interest in the operating company at a predetermined purchase price to the holding company, (5) require the operating company to pay a franchise fee to the governmental organization, (6) agree to use its governmental authority to facilitate collection of user charges. The ownership interest and control by the governmental organization in the operating company may be sufficient so the operating company may avoid payments to governmental entities otherwise imposed on a company lacking the ownership interest and control by a governmental organization. This may be especially advantageous in connection with trash collection.

Four, the agreement can also provide that the operating company may (1) have the exclusive right to provide services in the nature of a business in the geographical territory under the jurisdiction of the governmental organization, (2) agree to pay the holding company, at least in part, a management fee for management services extended to the operating company, for example, a management fee based on a percent of the revenues generated by the jointly owned operating company, (3) guarantee that certain environmental standards are met and agree to pay any fines for failure to meet these standards, (4) indemnify the governmental organization against claims of third parties or users, for example, for damages in connection with improper disposal of hazardous materials.

Five, services in the nature of a business may be provided in collaboration with a plurality of governmental organizations where each individual governmental organization has jurisdiction over a separate geographical territory. In accordance with this feature, a privately owned investment company forms a plurality of subsidiary holding companies, and each one of these subsidiary holding companies forms an individual operating company in the territory of a different one of the governmental organizations. In other words, there is one operating company for each separate territory. Each one of the governmental organizations acquires an ownership interest in the individual operating company providing the service in its territory (the territory over which the governmental organization has jurisdiction). Profits generated by each individual operating company are shared with the governmental organization having jurisdiction over the territory in which the operating company is authorized by the governmental organization to provide services in the nature of a business.

These features are not listed in any rank order nor is this list intended to be exhaustive.

### DESCRIPTION OF DRAWING

Some embodiments of this invention, illustrating all its features, will now be discussed in detail. These embodiments depict the novel and non-obvious method of this invention as shown in the accompanying drawing, which is for illustrative purposes only. This drawing includes the following figures (Figs.), with like numerals indicating like parts:

FIG. 1 is a schematic diagram of a business method where a joint venture operating company collects trash in the territory over which a governmental organization has jurisdiction.

FIG. 2A is a schematic diagram illustrating one embodiment of the present invention.

FIG. 2B is a schematic diagram illustrating another embodiment of the present invention.

### DETAILED DESCRIPTION OF SOME EMBODIMENTS OF THIS INVENTION

This invention involves a new business method for trash collection. Although this business method is particularly suited for trash collection, it may also be adapted to conduct (a) street sweeping, (b) distributing, maintaining and collecting portable toilets at municipal construction sites, and (c) towing of abandoned or illegally parked vehicles,

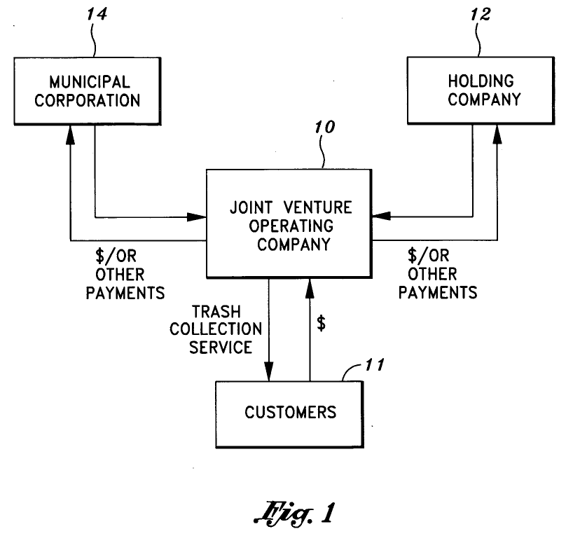

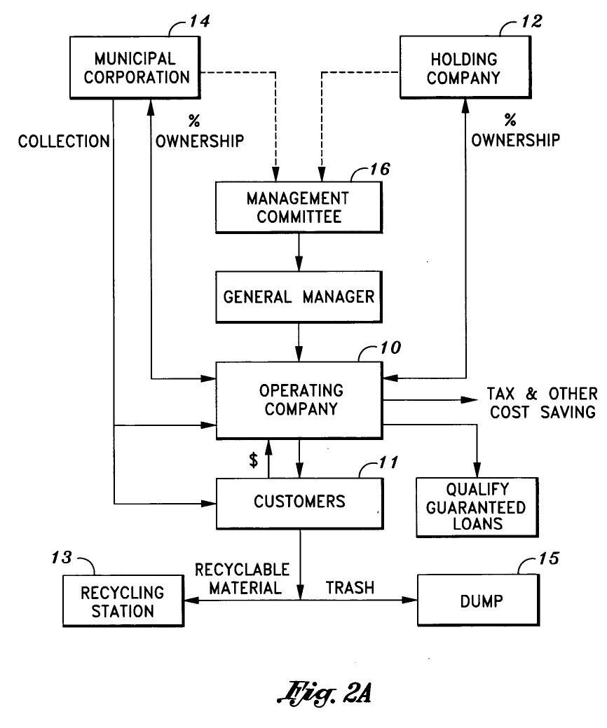

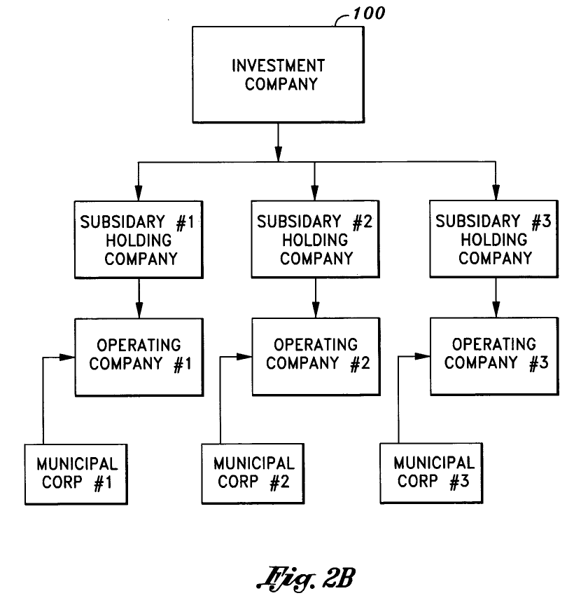

As shown in FIGS. 1 and 2, this new business method calls for trash collection by a joint venture operating company 10 in which a holding company 12 and a governmental organization, for example a municipal corporation 14, each have an ownership interest. The operating company 10 collects trash from customers 11 (residents or businesses) located in the territory over which the municipal corporation 14 has jurisdiction. Any recyclable material would be separated from trash and sent to a recycling station 13 and the trash sent to a dump 15. The customers 11 would be charged by the operating company 10 for the trash collection services it provides, and these charges paid by customers would constitute, at least in part, the revenues ($) of the operating company 10. Other potential sources of revenues may be buying and selling of recyclable material, the operation of a buy back center for purchasing recyclable materials, and income derived from the joint venture operating company 10 providing trash collection services outside the territorial jurisdiction of the municipal corporation 14. Profits equal revenues ($) minus expenses. These profits may be distributed between the municipal corporation 14 and the holding company 12 as discussed subsequently in greater detail.

This new business method enables a governmental organization such as the municipal corporation 14 simultaneously (a) to arrange for trash collection within its territorial jurisdiction in the most cost-effective and efficient manner that maximizes customer satisfaction, (b) to generate a new source of income unavailable to governmental organizations until this invention, (c) to create a valuable asset, namely an ownership interest in a profitable business, the joint venture operating company 10, and (d) to meet mandated environmental standards, with a guarantee by the joint venture operating company 10, who will pay any fines imposed for failure to meet these standards. It may also be required not to commingle the trash of the customers in the territory of the municipal corporation 14 with trash from sources outside the territory of the municipal corporation. The joint venture operating company 10 may also guarantee that no commingling will occur and pay any fines imposed if such commingling occurs. The joint venture operating company 10 may also assume liability for improper disposal of hazardous materials.

Typically, the operating company 10 will have an exclusive right or franchise to collect trash in the territory of the municipal corporation 14. In general, an exclusive franchise would be the most economically advantageous arrangement for both the municipal corporation 14 and the holding company 12 because their common ownership aligns their economic interests to maximize the profitability of the operating company 10. For example, instead of having a number of different trash collection companies franchised by the municipal corporation 14, the municipal corporation may grant to the operating company 10 the exclusive right to collect trash in the geographical territory over which the municipal corporation has jurisdiction. Both the municipal corporation 14 and the holding company 12 are interested in maximizing the profitability of the operating company 10 because they share any profits generated by the operating company 10. Sharing profits may be in the form of cash dividends, stock options, warrants, stock grants, distribution of property, or other payments to the owners of the operating company. As discussed in greater detail subsequently, the municipal corporation 14 through the members of a management committee 16 it elects, or appoints, actively participates in the management of the operating company 10 and has access to the financial records of the operating company.

The holding company 12 may be any suitable business organization, such as, for example, a sole proprietorship, a corporation, a partnership, a limited liability company, or a joint venture comprising a number of entities. Typically, a governmental organization would not have any ownership or other interest in the holding company 12. Likewise, the operating company 10 may be any suitable business organization, such as, for example, a corporation, a partnership, a limited liability company, or a joint venture comprising a number of entities; at least one of the participants of this business organization, however, is a governmental organization such as the municipal corporation 14. For example, the municipal corporation 14 may own 40% of the common stock of a corporation formed as the operating company 10 to collect the trash within the geographical territory over which the municipal corporation has jurisdiction and the holding company 12 may own 60% of the common stock of the corporation formed as the operating company 10.

The holding company 12 provides the management and technical expertise required to collect trash in an environmentally sound, cost-effective and efficient manner that satisfies the needs of customers. Providing management and technical expertise may be accomplished directly by individual members appointed to the management committee 16 by the holding company 12, or by a general manager selected by the holding company, or indirectly through, for example, individuals who are managers of an investment company 100 (FIG. 2B) discussed subsequently in greater detail. The management and technical expertise includes (a) selecting trash collection vehicles, (b) designing collection routes, (c) hiring personnel, (d) planning and coordinating the distribution of trash containers, (e) preparing informational materials for customers 11, (f) developing and implementing customer service programs, (g) employee training, and (h) conducting waste audits to confirm compliance with mandated environmental recycling standards. The informational materials, for example, brochures fostering recycling may be distributed to customers in order to meet statutory mandated educational programs. These informational materials may include newspaper articles, newsletters, public service announcements over radio and television, booklets, videos, audio tapes, posters, and field trips to recycling centers, landfills, and transfers stations. Informational materials provided through schools teach children the importance of recycling.

One feature of the method of this invention is that the joint venture operating company 10 guarantees that the mandated State and/or Federal environmental standards are met. If not, the joint venture operating company 10 will reimburse the municipal corporation 14 or pay any fine imposed upon the municipal corporation 14 for failure to meet these standards. Moreover, the joint venture operating company 10 may indemnify the municipal corporation 14 for any liability due to improper disposal of hazardous materials or improper commingling.

The holding company 12 may also provide access to financial resources needed to start-up the joint venture operating company 10. Access to the financial resources may be in the form of direct investment of capital in return for an ownership interest in the joint venture operating company 10, or a loan, or serving as a broker or finder that arranges for capital investments, loans or both in the operating company 10 from the general public, banks, or the investment company 100 (FIG. 2B). The holding company 12 may provide this access directly or through a related company, for example, through a parent company or a sister company commonly owned by the same parent company, for example, the investment company 100 (FIG. 2B).

Joint ownership of the operating company 10 enables the municipal corporation 14 to participate in the management of the operating company and have access to accounting records and reports. For example, the municipal corporation 14 and the holding company 12 form the management committee 16 for the operating company 10 comprising members elected or appointed by both the holding company and the municipal corporation. Elected officials and/or professional city managers may serve as members elected or appointed by the municipal corporation 14. The holding company 12 and the municipal corporation 14 may each appoint to the management committee 16 an equal number of committee members or the holding company 12 may appoint a majority of the members of the management committee. Among other things, this enables the municipal corporation 14 to propose increases in charges to be paid by customers of the trash collection services provided by the operating company 10, to suggest or even require certain days and time for trash collection, and/or to have access to accounting records and reports. The elected representatives of the municipal corporation 14, for example the city council, may have the authority to approve those members appointed by the municipal corporation, the charges paid by customers, routes, the days and times of services, or other operating requirements. The members of the management committee 16 would have the power to employ and discharge a general manger of the operating company 10 responsible for operations. In the case of a corporation, the board of directors would serve as the management committee 16. The general manger may also serve on the management committee 16, although this is optional. The agreement between the municipal corporation 14 and the holding company 12 may call for the distribution of profits on a quarterly basis, for example, based on percent ownership or otherwise, such as for example 40% of the profits to be paid the municipal corporation and 60% of the profits to be paid the holding company. The agreement may provide that the management committee 16 be authorized to withhold a portion of the quarterly profits as a reserve. Moreover, because of the participation in the management committee by officials of the municipal corporation 14, charges to customers may only be increased with the officials consent.

An agreement establishes the legal and business relationship between the municipal corporation 14 and the holding company 12. Briefly, this agreement provides for the operating company 10 to collect trash in the geographical territory over which the municipal corporation 14 has jurisdiction and the authority over trash collection. This governmental jurisdiction and authority may or may not be exclusive, and more that one governmental organization may participate in ownership of the operating company 10. The agreement may provide that the joint venture operating company 10 be operated in perpetuity, or that after a fixed period the operations of the joint venture operating company 10 be terminated, or that with notice either the municipal corporation 14 or the holding company 12 may terminate the agreement. The municipal corporation 14 may be required to forego selling its ownership interest in the operating company 10 for a predetermined period, for example, 5 (five) years. The municipal corporation 14 may have the right to sell all, or a portion of, the municipal corporation's ownership interest in the operating company 10 to the holding company 12. Alternately, the holding company 12 may have the exclusive right to purchase all, or a portion of, the governmental organization's ownership interest in the operating company 10 after a period of time. The purchase price may be at fair market value, or according to a predetermined formula agreed upon for establishing the purchase price of the municipal corporation's ownership interest in the joint venture operating company 10 at the time of sale, or at a fixed price. For example, four (4) times net profits of the operating company 10 but no less than a fixed amount such as Three Million Dollars ($3,000,000). In the case of a purchase of the municipal corporation's ownership interest in the operating company 10, the operating company 10 may be granted a franchise for at least a fixed period of years, for example five years, after the purchase of the municipal corporation's ownership interest. The holding company 12 may provide at least in part management services to the operating company 10 and be paid a management fee. This management fee may be a fixed amount paid periodically or it may be based on a percent of the revenues ($) generated by the operating company. The operating company 10 may also pay the municipal corporation 14 a franchise fee for the right to collect trash in the geographical territory over which the municipal corporation has jurisdiction. The terms of the agreement in Appendix A are exemplary of a suitable agreement between the municipal corporation 14 and the holding company 12.

As depicted in FIG. 2A, one embodiment of the method of conducting trash collection according to this invention calls for forming the operating company 10 in accordance with established statutory requirements in order to qualify for certain economic rewards. For example, the joint venture operating company 10 will be able to issue bonds that are guaranteed by a governmental organization such as a State government, provided certain standards established by law are met. For example, the percent ownership by the municipal corporation 14 may have to be a certain minimum. Other statutory standards may also have to be met.

The operating company 10 would normally own or lease the equipment used to collect the trash and hire employees or independent contractors to conduct operations. This equipment may be used only in connection with trash collection in the territory of over which the municipal corporation 14 has jurisdiction, or it may also be used in connection with trash collection in other territories normally with the profits from trash collection in other territories shared with the municipal corporation 14. The later case would normally not be undertaken if such extraterritorial trash collection disqualifies the operating company 10 from receiving the desired statutory economic rewards unless the revenues from these extra-territorial operations exceed the statutory economic rewards.

There are other advantages that may be afforded the operating company 10 due to the ownership interest of the municipal corporation 14. The enforcement authority of the municipal corporation 14 may be used directly or indirectly to collect monies from customers 11 who are delinquent in paying the charges imposed by the operating company 10 for trash collection services. Failure of the operating company 10 to collect trash in a timely manner could result in a public heath or safety problem. Consequently, the operating company 10 may not simply stop trash collection for delinquent customers. Because of the business relationship or ownership interest of the municipal corporation 14, the municipal corporation may impose a lien on the property of a delinquent customer 11 or employ other enforcement measures such as shutting off a delinquent user's water.

Another possible advantage afforded the operating company 10 due to the ownership interest of the municipal corporation 14 is the avoidance of certain taxes. For example, the operating company 10 may qualify for an exemption for taxes on gasoline, tires, etc. to certain governmental entities, for example State or Federal governments, otherwise imposed on a trash collection company lacking an ownership interest by the municipal corporation 14. For the operating company 10 to enjoy these tax benefits it may be required to meet certain criteria. For example, the municipal corporation 14 must bear certain economic risks, it must control the operating company, and any private participants must be paid a fixed fee. These criteria will vary depending on the then current tax laws affecting the operating company 10 and/or the municipal corporation 14.

As depicted in FIG. 2B, another embodiment of the method of according to this invention calls for conducting trash collection concurrently in collaboration with a plurality of different governmental organizations, each individual governmental organization having jurisdiction over a separate geographical territory. As illustrated, the investment company 100 serves as the repository of the management and technical expertise needed to conduct the operations of a joint venture operating company. This investment company 100 may also provide the capital for starting up operations of a joint venture operating company. Because separate governmental organizations have responsibility for trash collection in their individual territories, the investment company 100 forms a separate holding company for each individual governmental organization.

In the embodiment illustrated in FIG. 2B, the investment company 100 forms three separate wholly owned subsidiary holding companies identified as subsidiary #1, subsidiary #2, and subsidiary #3. Each subsidiary holding company works with only one of the three (3) different municipal corporations, municipal corporation #1, municipal corporation #2, and municipal corporation # 3, to form separate operating companies identified by the numerals #1, #2, and # 3. Subsidiary #1, subsidiary #2, and subsidiary #3 and each different municipal corporation, namely, municipal corporation #1, municipal corporation #2, and municipal corporation #3, would have a joint ownership interest in the respective operating companies #1, #2, and #3. Each one of the different operating companies would collect trash in the territory of each one of the municipal corporations under mutually acceptable terms such as discussed above.

### SUMMARY

The operating company 10 is designed to comply with all regulatory requirements imposed on trash collection operations and the municipal corporation 14 receives a guarantee to comply with mandated environmental standards and is indemnified against loss and/or liability for improper disposal of hazardous waste. Accounting protocols and financial controls are established wherein profit sharing based on the pre-established financial criteria (for example, 60% holding company ownership interest and 40% municipal corporation ownership interest) aligns the economic interest of the municipal corporation 14 and the holding company 12. Specifically, profits are distributed according to the agreement between the municipal corporation 14 and the holding company 12. The operating company 10 is jointly managed by the municipal corporation 14 and the holding company 12 to insure compliance with regulatory requirements, accurate reporting of financial results, and sharing of profits. The municipal corporation 14 has the right to sell its ownership interest in the operating company 10 in order to raise cash and the holding company may purchase this interest at fair market value at the time of sale, a prior agreed price, or formula for determining the price. Because of the ownership in the operating company 10 by the municipal corporation 14, operational and tax benefits may be available the operating company that are not available to a trash collection company not at least partially owned by a governmental organization.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A method of conducting services in the nature of a business in collaboration with a governmental organization comprising forming an operating company jointly owned by a privately owned holding company and the governmental organization to provide such services in the geographical territory over which the governmental organization has jurisdiction.

2. The method of claim 1 where said services comprise street sweeping.

3. The method of claim 1 where said services comprise distributing, maintaining and collecting portable toilets.

4. The method of claim 1 where said services comprise towing of abandoned or illegally parked vehicles.

5. The method of claim 1 where said services comprise trash collection.

6. A method of conducting trash collection comprising
(a) forming an operating company jointly owned by a holding company and a governmental organization to collect trash in the geographical territory over which the governmental organization has jurisdiction,
(b) establishing accounting protocols and financial controls for the operating company to determine the profits of the operating company,
(c) sharing profits between the governmental organization and the holding company.

7. The method of claim 6 where said operating company is jointly managed by the governmental organization and the holding company.

8. A method of conducting services in the nature of a business in collaboration with a governmental organization comprising forming an operating company jointly owned by a holding company and the governmental organization to provide said services in the geographical territory over which the governmental organization has jurisdiction, said operating company being granted by the governmental organization the exclusive right to provide said services in said geographical territory.

9. The method of claim 8 where the services comprise trash collection.

10. The method of claim 9 where the governmental organization and the holding company share profits generated by the operating company.

11. The method of claim 10 where the governmental organization foregoes selling its ownership interest in the operating company for a predetermined period.

12. The method of claim 10 where the governmental organization has the right to sell all or a portion of the governmental organization's ownership interest in the operating company.

13. The method of claim 12 where the purchase price of the governmental organization's ownership interest in the operating company is predetermined and the holding company has the right to purchase the governmental organization's ownership interest at said predetermined purchase price.

14. The method of claim 9 where the governmental organization and the holding company form a management committee for the operating company comprising members appointed by both the holding company and the governmental organization.

15. The method of claim 14 where the holding company and the governmental organization each appoint to the management committee an equal number of committee members, said members having the power to employ and discharge a general manger of the operating company responsible operations.

16. The method of claim 9 where the ownership interest and control by the governmental organization in the operating company is sufficient so the operating company may avoid payments to governmental entities otherwise imposed on a trash collection company lacking said ownership interest and control by a governmental organization.

17. The method of claim 9 where the governmental organization has the right to use its governmental authority to facilitate collection of charges to customers.

18. The method of claim 9 where the holding company provides at least in part management services to the operating company and is paid a management fee.

19. The method of claim 9 where the operating company pays a franchise fee to the governmental organization.

20. The method of claim 9 where the operating company guarantees that certain environmental standards are met and pays any fines for failure to meet these standards.

21. The method of claim 9 where the operating company indemnifies the governmental organization against claims for improper disposal of hazardous materials.

22. A method of conducting trash collection comprising forming an operating company jointly owned by a holding company and a governmental organization to collect trash in the geographical territory over which the governmental organization has jurisdiction, said governmental organization participating in the management of the operating company and sharing profits of the operating company.

23. The method of claim 22 where the operating company has the exclusive right to collect trash in said geographical territory.

24. A method of conducting trash collection comprising forming an operating company jointly owned by a holding company and a governmental organization to collect trash in the geographical territory over which the governmental organization has jurisdiction under mutually acceptable terms including
(i) the governmental organization foregoing selling its ownership interest in the operating company for a predetermined period,
(ii) the governmental organization and the holding company sharing profits generated by the operating company,
(iii) the governmental organization and the holding company forming a management committee for the operating company, each appointing at least one member to the management committee.

25. The method of claim 24 where the management committee has the power to employ and discharge a general manger of the operating company responsible for operations, said general manger during his or her term of employment serving as a member of the management committee.

26. A method of conducting services in the nature of a business in collaboration with a plurality of governmental organizations, each individual governmental organization having jurisdiction over a separate geographical territory,
said method comprising
(a) forming a privately owned investment company,
(b) said investment company forming a plurality of subsidiary holding companies,
(c) each one of said subsidiary holding companies forming an individual operating company to collect trash in the territory of a different one of said governmental organizations, each one of governmental organizations acquiring an ownership interest in the individual operating company providing said services in the territory of said one governmental organization and sharing any profits generated by said individual operating company.

27. The method of claim 26 where the services comprise trash collection.

28. The method of claim 27 where each said individual operating company has the exclusive right to collect trash in the geographical territory of said one governmental organization that has an ownership interest in the individual operating company.

29. The method of claim 28 where said one governmental organization foregoes selling its ownership interest in the operating company for a predetermined period.

30. The method of claim 29 where each individual governmental organization has the right to sell all, or a portion of, said individual governmental organization's ownership interest in the mutually owned operating company to the subsidiary holding company having an ownership interest in said operating company.

31. The method of claim 30 where there is a predetermined formula for establishing the purchase price of said one governmental organization's ownership interest in the operating company.

32. The method of claim 30 where said one governmental organization and the subsidiary holding company form a management committee for the mutually owned operating company comprising members appointed by both the subsidiary holding company and said one governmental organization.

33. The method of claim 31 where the subsidiary holding company and said one governmental organization each appoint to the management committee at least one committee member, said management committee having the power to employ and discharge a general manger of the operating company responsible for operations.

34. The method of claim 27 where the ownership interest and control by said one governmental organization in the mutually owned operating company is sufficient so the operating company may avoid payments to governmental entities otherwise imposed on a trash collection company lacking said ownership interest and control by a governmental organization.

35. The method of claim 27 where the governmental organization has the power to use its governmental authority to facilitate collection of charges to customers.

36. The method of claim 27 where the subsidiary holding company provides at least in part management services to the operating company and is paid a management fee based on a percent of the revenues generated by the mutually owned operating company.

37. The method of claim 27 where the mutually owned operating company pays a franchise fee to said one governmental organization.

38. A method of conducting services in the nature of a business in collaboration with a plurality of different governmental organizations, each individual governmental organization having jurisdiction over a separate geographical territory,
said method comprising
(a) forming a non-governmental owned investment company,
(b) said investment company forming a plurality of subsidiary holding companies,
(c) each one of said subsidiary holding companies forming an operating company to provide said services in the territory of a different one of said governmental organizations wherein
(i) said one governmental organization acquires an ownership interest in the operating company and shares any profits generated by the operating company.
(ii) said operating company has the exclusive right to provide said services in the geographical territory of said one governmental organization,
(iii) said one governmental organization foregoes selling its ownership interest in the operating company for a predetermined period,
(iv) said one subsidiary holding company has the exclusive right to purchase all of said one governmental organization's ownership interest in the operating company.

39. The method of claim 38 where a pre-established purchase price has been agreed upon.

40. A business method where a joint venture operating company in which a governmental organization has an ownership interest collects trash, said joint venture operating company primarily collecting trash from customers located in the territory over the governmental organization has jurisdiction.

41. The method of claim 40 where the joint venture operating company has an exclusive right to collect trash in said territory.

42. The method of claim 41 where the joint venture operating company pays the governmental organization monies based on profits generated by joint venture operating company.

43. A business method where a joint venture operating company in which a governmental organization has an ownership interest renders a service primarily to customers located in the territory over the governmental organization has jurisdiction, said joint venture operating company employing in connection with rendering said service an automotive vehicle that travels throughout the geographical territory over which the governmental organization has jurisdiction, said governmental organization granting to the joint venture operating company the exclusive right to provide said service within said geographical territory.
